(19) United States
(12) Patent Application Publication
(10) Pub. No.: US 2021/0067465 A1
(43) Pub. Date: Mar. 4, 2021

(54) IDENTIFYING TARGET PORT BASED ON RESOURCE AVAILABILITY

(71) Applicant: International Business Machines Corporation, Armonk, NY (US)

(72) Inventors: Abhishek Jain, Baraut (IN); Subhojit Roy, Pune (IN); Digambar Ingale, Ravet (IN); Abhijeet Indulkar, Talegon (IN)

(21) Appl. No.: 16/551,851

(22) Filed: Aug. 27, 2019

(51) Int. Cl. H04L 12/937; H04L 12/935; G06F 13/22

(52) U.S. Cl. CPC H04L 49/254; G06F 13/225; H04L 49/3081

(57) ABSTRACT

A command is received from a first computer. The command is to transfer a data from the first computer to a second computer. One or more ports of the second computer are determined that are available for the data transfer. A ranking is determined for the one or more ports. The first computer is notified of one or more data transfer ports of the one or more ports. The one or more data transfer ports are above a threshold in the determined ranking.

### BACKGROUND

The present invention relates generally to the field of remote data storage, and more particularly to identifying a target port to transfer data based on resource availability of the port.

In a storage area network (SAN), remote computer storage devices such as disk arrays can be made accessible to host computers so that the storage devices appear as if they are locally attached to the host computer's operating system. SANs may be implemented using Small Computer System Interface (SCSI) storage devices, in which SCSI protocol entities perform input/output (I/O) operations (e.g., data reads and writes) and are exposed through a unique identifier such as a logical unit number (LUN) on a path. A given LUN typically corresponds to a logical volume and may be represented within the host computer's operating system as a device. Interaction with a LUN is initiated by a SCSI initiator port on a host computer, which can issue various I/O request types to the LUN on a target data storage device.

iSCSI is an IP-based standard for linking data storage devices over a network and transferring data by carrying SCSI commands over IP networks. iSCSI stands for Internet Small Computer System Interface, which consists of two major components SCSI command for storage and IP commands for networking. iSCSI helps transporting block level data between iSCSI initiator on server and an iSCSI target on storage.

### SUMMARY

Embodiments of the present invention include a method, computer program product, and system for data transfer. In one embodiment, a command is received from a first computer. The command is to transfer a data from the first computer to a second computer. One or more ports of the second computer are determined that are available for the data transfer. A ranking is determined for the one or more ports. The first computer is notified of one or more data transfer ports of the one or more ports. The one or more data transfer ports are above a threshold in the determined ranking.

### BRIEF DESCRIPTION OF THE DRAWINGS

FIG. 1 is a functional block diagram of a network computing environment, generally designated 100, suitable for operation of storage program 122, in accordance with at least one embodiment of the invention.

FIG. 2 is a flow chart diagram depicting operational steps for storage program 122, in accordance with at least one embodiment of the invention.

FIG. 3 is a flow chart diagram depicting operational steps for storage program 122, in accordance with at least one embodiment of the invention.

FIG. 4 is an example embodiment of statistics of ports and their rankings, in accordance with at least one embodiment of the invention.

FIG. 5 is a block diagram depicting components of a computer, generally designated 400, suitable for executing storage program 122, in accordance with at least one embodiment of the invention.

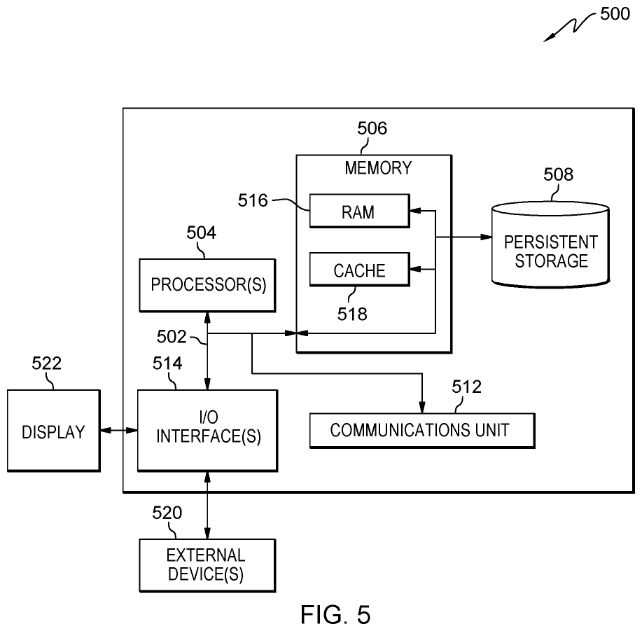

### DETAILED DESCRIPTION

Data transfer between two devices can suffer degradation due to multiple issues. In a normal iSCSI discovery process, the iSCSI initiator issues a SendTarget discovery request to a iSCSI target storage system. The iSCSI target storage system returns all iSCSI ports to the iSCSI initiator that are available for establishing iSCSI connections on that IQN.

In this mechanism the initiator receives all paths from iSCSI target in SendTarget query response and lands up establishing iSCSI sessions to all paths returned by iSCSI target. Now there are scenarios when ports are configured to serve 10 workloads such as IP replication, iSCSI backend virtualization, clustering etc. In such situations, the initiator ends up creating sessions with target ports that are already loaded with other workloads activities, without any prior knowledge during the SendTarget discovery process thereby reducing the read/write performance of the host when talking to some of the overloaded ports. The Host can suffer high latency on those target ports that are already serving heavy 10 activities. Embodiments of the present invention recognize that a solution is needed to solve these potentially high latency issues. Embodiments of the present invention solve this problem by controlling the port availability on the host side based on statistics associated with each port.

Embodiments of the present invention provide for a data transfer optimization program, such as storage program 122. Embodiments of the present invention provide for determining ports available for data transfer that are associated with nodes. Embodiments of the present invention provide for determining statistical data about each of the ports. Embodiments of the present invention provide for ranking the ports based on the determined statistics. Embodiments of the present invention provide for checking for updates to both the statistics and the rankings. Embodiments of the present invention provide for receiving a command from an initiator for data transfer. Embodiments of the present invention provide for determining ports available for the data transfer. Embodiment of the present invention provide for notifying the initiator of the port, based on the ranking, that should be used for data transfer. Embodiments of the present invention provide for providing an update on the ports to the initiator based on receiving an updated ranking of the ports.

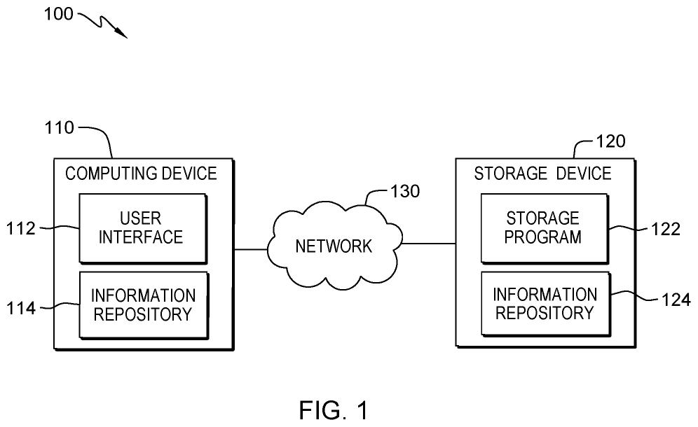

Referring now to various embodiments of the invention in more detail, FIG. 1 is a functional block diagram of a network computing environment, generally designated 100, suitable for operation of storage program 122 in accordance with at least one embodiment of the invention. FIG. 1 provides only an illustration of one implementation and does not imply any limitation with regard to the environments in which different embodiments may be implemented. Many modifications to the depicted environment may be made by those skilled in the art without departing from the scope of the invention as recited by the claims.

Network computing environment 100 includes computing device 110 and storage device 120 interconnected over network 130. In embodiments of the present invention, network 130 can be a telecommunications network, a local area network (LAN), a wide area network (WAN), such as the Internet, or a combination of the three, and can include wired, wireless, or fiber optic connections. Network 130 may include one or more wired and/or wireless networks that are capable of receiving and transmitting data, voice, and/or video signals, including multimedia signals that include voice, data, and video formation. In general, network 130 may be any combination of connections and protocols that will support communications between computing device 110, storage device 120, and other computing devices (not shown) within network computing environment 100.

Computing device 110 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, computing device 110 represents any programmable electronic devices or combination of programmable electronic devices capable of executing machine readable program instructions and communicating with storage device 120, and other computing devices (not shown) within computing environment 100 via a network, such as network 130.

In various embodiments of the invention, computing device 110 may be a computing device that can be a standalone device, a management server, a web server, a media server, a mobile computing device, or any other programmable electronic device or computing system capable of receiving, sending, and processing data. In other embodiments, computing device 110 represents a server computing system utilizing multiple computers as a server system, such as in a cloud computing environment. In an embodiment, computing device 110 represents a computing system utilizing clustered computers and components (e.g. database server computers, application server computers, web servers, and media servers) that act as a single pool of seamless resources when accessed within network computing environment 100.

In various embodiments of the invention, computing device 110 includes user interface 112 and information repository 114.

In an embodiment, computing device 110 includes a user interface 112. User interface 112 is a program that provides an interface between a user and an application. User interface 112 refers to the information (such as graphic, text, and sound) a program presents to a user and the control sequences the user employs to control the program. There are many types of user interface 112. In one embodiment, user interface 112 may be a graphical user interface (GUI). A GUI is a type of user interface that allows users to interact with electronic devices, such as a keyboard and mouse, through graphical icons and visual indicators, such as secondary notations, as opposed to text-based interfaces, typed command labels, or text navigation. In computers, GUIs were introduced in reaction to the perceived steep learning curve of command-line interfaces, which required commands to be typed on the keyboard. The actions in GUIs are often performed through direct manipulation of the graphics elements.

In an embodiment, computing device 110 includes information repository 114. In an embodiment, information repository 114 may be managed by the operating system of computing device 110 or another program (not shown). Information repository 114 is a data repository that can store, gather, and/or analyze information. In some embodiments, information repository 114 is located externally to computing device 110 and accessed through a communication network, such as network 130. In some embodiments, information repository 114 is stored on computing device 110. In some embodiments, information repository 114 may reside on another computing device (not shown), provided information repository 114 is accessible by computing device 110. Information repository 114 includes, but is not limited to, any type of data that is stored on computing device 110 that may be transferred to storage device 120.

Information repository 114 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 114 may be implemented with any suitable storage architecture known in the art, such as a relational database, an object-oriented database, or one or more tables.

Storage device 120 is a computing device that can be a laptop computer, tablet computer, netbook computer, personal computer (PC), a desktop computer, a personal digital assistant (PDA), a smartphone, smartwatch, or any programmable electronic device capable of receiving, sending, and processing data. In general, storage device 120 represents any programmable electronic devices or combination of programmable electronic devices capable of executing machine readable program instructions and communicating with computing device 110, and other computing devices (not shown) within computing environment 100 via a network, such as network 130.

In various embodiments of the invention, storage device 120 may be a computing device that can be a standalone device, a management server, a web server, a media server, a mobile computing device, or any other programmable electronic device or computing system capable of receiving, sending, and processing data. In other embodiments, storage device 120 represents a server computing system utilizing multiple computers as a server system, such as in a cloud computing environment. In an embodiment, storage device 120 represents a computing system utilizing clustered computers and components (e.g. database server computers, application server computers, web servers, and media servers) that act as a single pool of seamless resources when accessed within network computing environment 100.

In various embodiments of the invention, storage device 120 includes storage program 122 and information repository 124.

In an embodiment, storage program 122 is a piece of software that can perform data transfer functions between storage device 120 and any other device (e.g., computing device 110). Embodiments of the present invention provide for a virtual storage program 122 that determines ethernet ports available for data transfer and statistics for data metrics of the ethernet ports. In embodiments of the present invention, storage program 122 ranks the ports based on the determined statistics. In embodiments of the present invention, storage program 122 checks for updates to the statistics. In embodiments of the present invention, storage program 122 notifies a requesting initiator of the rankings. In embodiment of the present invention, storage program 122 receives a command for data transfer to storage device from an initiator (e.g., computing device 110). In an embodiment, storage program 122 determines ports available to the initiator and the ranking of the respective ports.

In an embodiment, storage device 120 includes information repository 124. In an embodiment, information repository 124 may be managed by storage program 122. In an alternative embodiment, information repository 124 may be managed by the operating system of storage device 120, another program (not shown), alone, or together with, storage program 122. Information repository 124 is a data repository that can store, gather, and/or analyze information. In some embodiments, information repository 124 is located externally to storage device 120 and accessed through a communication network, such as network 130. In some embodiments, information repository 124 is stored on storage device 120. In some embodiments, information repository 124 may reside on another computing device (not shown), provided information repository 124 is accessible by storage device 120. In an embodiment, information repository 124 includes one or more storage nodes for data storage. In an embodiment, storage nodes may be direct attached, as shown by information repository 124, or network attached storage for storing the data over network 130 via an information repository found on another device (not shown). In an embodiment, storage nodes included a network adapter with multiple ports. In an embodiment, the ports may create connections for the data traffic between the software or dependent hardware adapters and the physical network adapters. In an embodiment, a network or communications controller may be used that plugs into the communication device via network 130 on the physical port.

Information repository 124 includes, but is not limited to, data (stored from an initiator), data, ethernet port information, node information, statistic information about ports, rankings of ports, threshold information, timing information, etc.

Information repository 124 may be implemented using any volatile or non-volatile storage media for storing information, as known in the art. For example, information repository 114 may be implemented with a tape library, optical library, one or more independent hard disk drives, multiple hard disk drives in a redundant array of independent disks (RAID), solid-state drives (SSD), or random-access memory (RAM). Similarly, information repository 124 may be implemented with any suitable storage architecture known in the art, such as a relational database, an object-oriented database, or one or more tables.

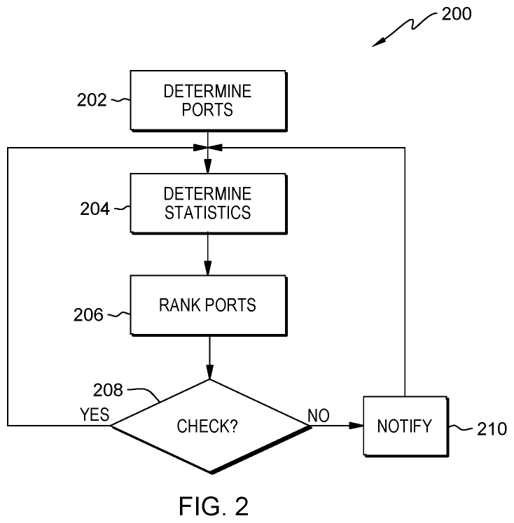

FIG. 2 is a flow chart diagram depicting operational steps of workflow 200 for storage program 122 in accordance with at least one embodiment of the invention. It should be appreciated that embodiments of the present invention provide at least for data transfer between computing device 110 to storage device 120. In an embodiment, a user may communicate, using the user interface 112 of computing device 110, to storage program 122 on storage device 120. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

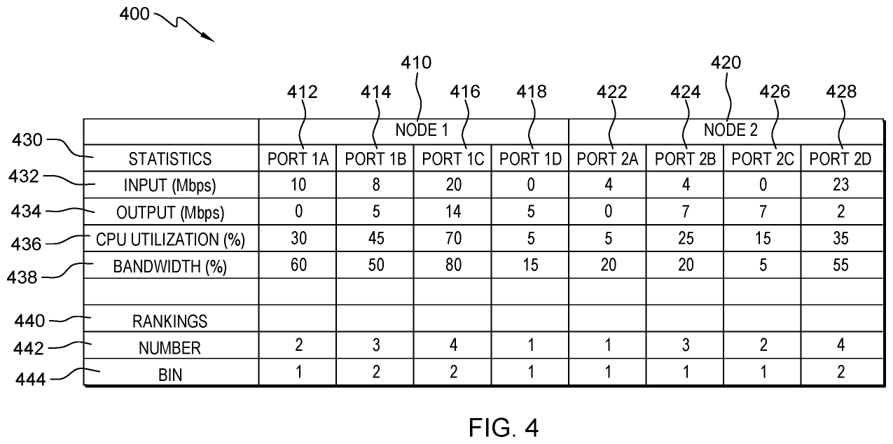

Storage program 122 determines ports (step 202). At step 202, storage program 122 determines the ports to be monitored and controlled by storage program 122. In an embodiment, a user, via user interface 112 of computing device, may indicate to storage program 122 the nodes including their respective ports or solely the ports that will be monitored and controlled by storage program 122. In an alternative embodiment, a user (e.g, administrator, IT support, etc.) of storage device 12 may indicate to storage program 122 the nodes including their respective ports or solely the ports that will be monitored and controlled by storage program 122. In a first example, a system administrator, via a user interface (not shown) of storage device 120, indicates to storage program 122 that storage program 122 will be monitoring and controlling node 1 and node 2. In this example, node 1 has ports 1A, 1B, 1C, and 1D and node 2 has ports 2A, 2B, 2C, and 2D, as shown in FIG. 4.

Storage program 122 determines statistics (step 204). At step 204, storage program 122 determines statistics about each of the ports that have been indicated to be monitored in step 202. In an embodiment, the statistics to monitor include, but are not limited to, input/output usage, CPU utilization, bandwidth, etc. In an embodiment, storage program 122 may query the operating system of storage device 120 or the appropriate programing of storage device 120 in order to determine the statistics. In an alternative embodiment, the operating system of storage device 120 or the appropriate programming of storage device 120 may provide the statistics at time periods or if there is a change above/below a threshold from the most previous reported statistic. In an example, storage program 122 may query the operating system of storage device 120 for the statistics of ports 1A, 1B, 1C, 1D, 2A, 2B, 2C, and 2D, as shown in FIG. 4. In this example, storage program 122 receives statistics about input/output usage, CPU utilization, and bandwidth for each of the nodes, as shown in FIG. 4.

Storage program 122 ranks the ports (step 206). At step 206, storage program 122 uses the determined statistics from step 204 to rank the determined ports of step 202. Here, storage program 122 determines a score using an algorithm that has a factor associated with each statistic. In other words, storage program 122 determines the score for each port and the ranking is determined using a factoring for each statistic. For example, input/output factor may be 30%, CPU utilization % factor may be 30% and bandwidth % factor may be 40%. Here, an overall score is determined for each port based on the factors and determined statistics. In a first embodiment, storage program 122 ranks each port relative to each other. In other words, a port is ranked number 1 (the best) to number x (the worst). Here, there is a ranking from 1 to x that includes all ports that are being ranked. In a second embodiment, storage program 122 ranks each port by placing a port in a “free” bin if the score is below a threshold and in a “used” bin if the score is above a threshold. In this embodiment, the “free” bin includes ports that would be usable for data transfer and the “used” bin would be for ports that should not be used for data transfer, in other words they are already being used and are not good candidates for new data transfers. In an embodiment, storage program 122 stores the rankings to information repository 124.

Storage program 122 checks for updates (decision step 208). At decision step 208, storage program 122 checks to see if there have been any updates to the statistics. In a first embodiment, storage program 122 will determine if a threshold period of time has passed since the last statistics were determined (step 204). In this embodiment, if a threshold period of time has passed, then storage program 122 will determine there have been updates to the statistics and if a threshold period of time has not passed, then storage program 122 will determine a there have not been updates to the statistics. In a second embodiment, the operating system or another program (not shown) updates the statistics in information repository 124 and storage program 122 will determine if there have been any changes to statistics found in information repository 124 based on the previous statistics determined (step 204) and used to rank ports (step 206). In a third embodiment, storage program 122 will determine the statistics based on the port usage and then determine if there are any changes to the statistics found in information repository 124 based on the previous statistics determined (step 204) and used to rank ports (step 206). In an embodiment, if there has been a change to the statistics (decisions step 208, yes branch), processing proceeds to step 204. In an embodiment, there has not been a change to the statistics (decision step 208, no branch), processing proceeds to step 210.

Storage program 122 notifies an initiator of the ports (step 210). At step 210, notifies the initiator of the ports that will be used for the data transfer based on the determined rankings (step 206). This step is substantially similar to step 306, discussed in detail below.

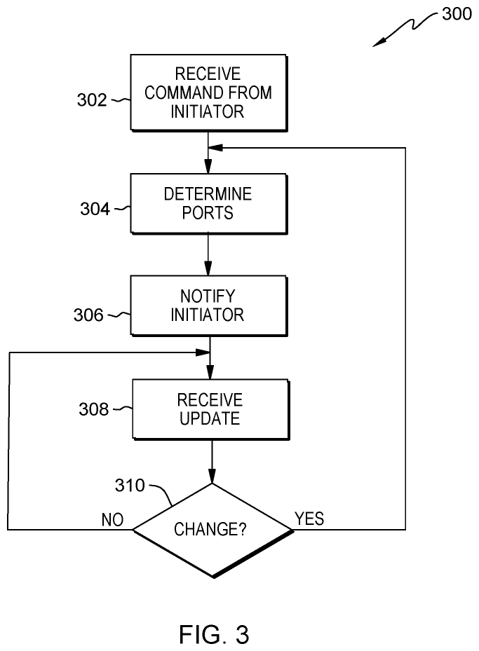

FIG. 3 is a flow chart diagram depicting operational steps of workflow 300 for storage program 122 in accordance with at least one embodiment of the invention. It should be appreciated that embodiments of the present invention provide at least for data transfer between computing device 110 to storage device 120. In an embodiment, a user may communicate, using the user interface 112 of computing device 110, to storage program 122 on storage device 120. However, FIG. 2 provides only an illustration of one implementation and does not imply any limitations with regard to the environments in which different embodiments may be implemented. Many modifications to the depicted environment may be made by those skilled in the art without departing from the scope of the invention as recited by the claims.

Storage program 122 receives a command from an initiator (step 302). At step 202, storage program 122 receives a command from computing device 110 to transfer data from information repository 114 on computing device 110 to information repository 124 on storage device 120. In an example, the iSCSI target (i.e., computing device 110) issues a SendTargetdiscovery command that the iSCSI target (i.e. storage device 120 via storage program 122) receives. In simple terms. The SendTargetdiscovery command is a request for all available ports that are available for establishing a connection for data transfer between the two devices.

Storage program 122 determines ports (step 304). At step 304, storage program 122 determines which ports of storage device 120 are available for data transfer. In a first embodiment, all data ports of storage device 120 may be used for data transfer. In a second embodiment, only part of the data ports of storage device 120 may be available based on metadata found information repository 124. In the second embodiment, a user (e.g., administrator, IT support, etc.) may previously have indicated, via storage program 122, a specific number of ports of storage device 120 that may be used for data transfer.

Once storage program 122 determines which ports are available for data transfer, storage program 122 determines the rankings in information repository 124 for each of the determined ports that was created in step 206. In an embodiment, storage program 122 will determine the threshold number of ports in the ranking of all the determined data ports for the data transfer (i.e. top three, top five, top 10). In an alternative embodiment, storage program 122 will determine the ports that are available for data transfer that are in the “free” bin (i.e. all of the ports in the “free” bin).

Storage program 122 notifies the initiator (step 306). At step 306, storage program 122 notifies the initiator (i.e. computing device 110) of the determined ports from step 304 that are available for data transfer. In an embodiment, storage program 122 may notify the initiator (i.e. computing device 110) of some or all of the determined ports. The initiator (i.e. computing device 110) may then begin and/or continue a data transfer using the determined data ports.

Storage program 122 receives an update to the ranking of the ports (step 308). At step 308, storage program 122 receives an update of the ranking of the ports from step 210. In other words, storage program 122 in workflow 200 is continually updating the ranking of the ports which culminates in step 210 and in step 308 storage program 122 will receive this updated ranking from step 210.

Storage program determines if there was a change in the ranking (decision step 310). At decision step 310, storage program 122 compares the previous ranking to the new ranking and determines if there was a change in the ranking of the ports. In an embodiment, if there has been a change to the rankings (decisions step 310, yes branch), processing proceeds to step 304. In an embodiment, there has not been a change to the rankings (decision step 310, no branch), processing proceeds to step 308.

FIG. 4 is a table 400 that is an example embodiment of statistics of ports and their rankings, in accordance with at least one embodiment of the invention. Table 400 shows node 1 410 and node 2 420 and in this example node 1 410 and node 2 420 may be found in information repository 124. Each of node 1 410 and node 2 420 have four separate ports for transferring data to each node, as shown by port 1A 412, port 1B 414, port 1C 416 and port 1D 418 for node 1 410 and port 2A 422, port 2B 424, port 2C 426, and port 2D 428 for node 2 420. In this example, table 400 includes statistics 430 for each of the port. The statistics recorded are input (Mbps) 432, output (Mbps) 434, CPU utilization (%) 436, and bandwidth (%) 438. Input 432 and output 434 are both measurements of data transfer in and out of the respective port. CPU utilization 436 is the percentage utilization of the CPU for the computer by the respective port. Bandwidth 438 is the percentage utilization of the total bandwidth available for data transfer for the respective port. Some or all of the statistics, as noted above, are used to determine rankings 440. In a first example, as discussed above, each port is ranked 1-4 for each node and a ranking of one is better than four but in other examples a ranking of four could be better than one. In other examples, each node may have any other number than four ports and the rankings would be from one to the total number of ports. In a second example, as discussed above, each port can be placed in a bin (one or two) and the bins may indicate that they are available for data transfer or not available for data transfer.

As depicted, the computer 500 operates over the communications fabric 502, which provides communications between the computer processor(s) 504, memory 506, persistent storage 508, communications unit 512, and input/output (I/O) interface(s) 514. The communications fabric 502 may be implemented with an architecture suitable for passing data or control information between the processors 504 (e.g., microprocessors, communications processors, and network processors), the memory 506, the external devices 520, and any other hardware components within a system. For example, the communications fabric 502 may be implemented with one or more buses.

The memory 506 and persistent storage 508 are computer readable storage media. In the depicted embodiment, the memory 506 comprises a random-access memory (RAM) 516 and a cache 518. In general, the memory 506 may comprise any suitable volatile or non-volatile one or more computer readable storage media.

Program instructions virtual storage program 122 may be stored in the persistent storage 508, or more generally, any computer readable storage media, for execution by one or more of the respective computer processors 504 via one or more memories of the memory 506. The persistent storage 508 may be a magnetic hard disk drive, a solid-state disk drive, a semiconductor storage device, read only memory (ROM), electronically erasable programmable read-only memory (EEPROM), flash memory, or any other computer readable storage media that is capable of storing program instruction or digital information.

The media used by the persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of the persistent storage 508.

The communications unit 512, in these examples, provides for communications with other data processing systems or devices. In these examples, the communications unit 512 may comprise one or more network interface cards. The communications unit 512 may provide communications through the use of either or both physical and wireless communications links. In the context of some embodiments of the present invention, the source of the various input data may be physically remote to the computer 500 such that the input data may be received, and the output similarly transmitted via the communications unit 512.

The I/O interface(s) 514 allow for input and output of data with other devices that may operate in conjunction with the computer 500. For example, the I/O interface 514 may provide a connection to the external devices 520, which may be as a keyboard, keypad, a touch screen, or other suitable input devices. External devices 520 may also include portable computer readable storage media, for example thumb drives, portable optical or magnetic disks, and memory cards. Software and data used to practice embodiments of the present invention may be stored on such portable computer readable storage media and may be loaded onto the persistent storage 508 via the I/O interface(s) 514. The I/O interface(s) 514 may similarly connect to a display 522. The display 522 provides a mechanism to display data to a user and may be, for example, a computer monitor.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disk read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adaptor card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, though the Internet using an Internet Service Provider). In some embodiments, electronic circuitry including, for example programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram blocks or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of computer program instructions, which comprises one or more executable instructions for implementing the specified logical function(s). In some alternative implementations, the functions noted in the block may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing form the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for data transfer, the method comprising the steps of:
receiving, by one or more computer processors, a command from a first computer, wherein the command is to transfer a data from the first computer to a second computer;
determining, by one or more computer processors, one or more ports of the second computer available for the data transfer;
determining, by one or more computer processors, one or more statistics for each port of the one or more ports;
determining, by one or more computer processors, a score for each port of the one or more ports based on the one or more statistics; and
ranking, by one or more computer processors, each port of the one or more ports based on the score for each port of the one or more ports;
responsive to a threshold period of time passing, checking, by one or more computer processors, for an update to any the one or more statistics for each port of the one or more ports;
updating, by one or more computer processors, the determined score for each port of the one or more ports;
updating, by one or more computer processors, the ranking for each port of the one or more ports using the updated determined score; and
notifying, by one or more computer processors, the first computer of one or more data transfer ports of the one or more ports, wherein the one or more data transfer ports are above a threshold in the updated determined ranking.

2. The computer-implemented method of claim 1, further comprising:
transferring, by one or more computer processors, the data from the first computer to the second computer using the one or more data transfer ports.

3. (canceled)

4. (canceled)

5. The computer-implemented method of claim 1, wherein the one or more statistics is selected from a group consisting of an input/output usage of a port, a CPU utilization, and a bandwidth.

6. The computer-implemented method of claim 1, wherein the step of determining, by one or more computer processors, a score for each port of the one or more ports based on the one or more statistics comprises:
determining, by one or more computer processors, a factor for each statistic of the one or more statistics; and
determining, by one or more computer processors, a score for each port of the one or more ports based on the factor for each statistic of the one or more statistics and the one or more statistics.

7. The computer-implemented method of claim 1, wherein the ranking is selected from a group consisting of the ranking of each port relative to each other port or the ranking of each port in a free bin or a used bin.

8. A computer program product for data transfer, the computer program product comprising:
one or more computer readable storage media; and
program instructions stored on the one or more computer readable storage media, the program instructions comprising:
program instructions to receive a command from a first computer, wherein the command is to transfer a data from the first computer to a second computer;
program instructions to determine one or more ports of the second computer available for the data transfer;
responsive to a threshold period of time passing, program instructions to check for an update to any the one or more statistics for each port of the one or more ports;
program instructions to update the determined score for each port of the one or more ports;
program instructions to update the ranking for each port of the one or more ports using the updated determined score; and
program instructions to notify the first computer of one or more data transfer ports of the one or more ports, wherein the one or more data transfer ports are above a threshold in the determined ranking.

9. The computer program product of claim 8, further comprising program instructions, stored on the one or more computer readable storage media, to:
transfer the data from the first computer to the second computer using the one or more data transfer ports.

10. (canceled)

11. (canceled)

12. The computer program product of claim 8, wherein the one or more statistics is selected from a group consisting of an input/output usage of a port, a CPU utilization, and a bandwidth.

13. The computer program product of claim 8, wherein the program instruction to determine a score for each port of the one or more ports based on the one or more statistics comprises:
program instructions to determine a factor for each statistic of the one or more statistics; and
program instructions to determine a score for each port of the one or more ports based on the factor for each statistic of the one or more statistics and the one or more statistics.

14. The computer program product of claim 8, wherein the ranking is selected from a group consisting of the ranking of each port relative to each other port or the ranking of each port in a free bin or a used bin.

15. A computer system for data transfer, the computer system comprising:
one or more computer processors;
one or more computer readable storage media; and
program instructions stored on the one or more computer readable storage media for execution by at least one of the one or more computer processors, the program instructions comprising:
program instructions to receive a command from a first computer, wherein the command is to transfer a data from the first computer to a second computer;
program instructions to determine one or more ports of the second computer available for the data transfer;
responsive to a threshold period of time passing, program instructions to check for an update to any the one or more statistics for each port of the one or more ports;
program instructions to update the determined score for each port of the one or more ports;
program instructions to update the ranking for each port of the one or more ports using the updated determined score; and
program instructions to notify the first computer of one or more data transfer ports of the one or more ports, wherein the one or more data transfer ports are above a threshold in the determined ranking.

16. The computer system of claim 15, further comprising program instructions, stored on the one or more computer readable storage media for execution by the at least one of the one or more computer processors, to:
transfer the data from the first computer to the second computer using the one or more data transfer ports.

17. (canceled)

18. (canceled)

19. The computer system of claim 15, wherein the one or more statistics is selected from a group consisting of an input/output usage of a port, a CPU utilization, and a bandwidth.

20. The computer system of claim 15, wherein the program instruction to determine a score for each port of the one or more ports based on the one or more statistics comprises:
program instructions to determine a factor for each statistic of the one or more statistics; and
program instructions to determine a score for each port of the one or more ports based on the factor for each statistic of the one or more statistics and the one or more statistics.
